(19) United States
(12) Patent Application Publication
(10) Pub. No.: US 2011/0304113 A1
(43) Pub. Date: Dec. 15, 2011

(54) Laundry Buddy

(76) Inventor: Deborah L. Clover, Phoenix, AZ (US)

(21) Appl. No.: 13/134,364

(22) Filed: Jun. 6, 2011

Related U.S. Application Data
(60) Provisional application No. 61/396,905, filed on Jun. 4, 2010.

(51) Int. Cl. B62B 3/00

(52) U.S. Cl. 280/47.34

(57) ABSTRACT

The present invention, hereinafter referred as the Laundry Buddy, is a specially designed laundry basket, comprising heavy duty wheeled castors which facilitate three hundred sixty degrees of rotation and an easily attached handle that enables the user to effortlessly transport the basket about the home. The Laundry Buddy boasts a mesh-like grate on the sidewalls, facilitating the free flow of air about laundry contained within. Positioned at each end of the unit are integrated handles for use in easily lifting the basket off the ground. Further, a recessed niche is centrally positioned on one end of the unit, inside of which, a sturdy handle is easily attached via an interlocking hinged fastener. As an added design feature, this handle is comprised of retractable, telescoping components and thus rests flush against the side of the basket when not in use, extending several feet in length when fully extended to accommodate the stature of an adult user. A nonskid, oval shaped handgrip is perpendicularly attached to the top of the handle, facilitating easy maneuvering of the Laundry Buddy.

### CLAIM OF PRIORITY

This patent application claims priority under 35 USC 119 (e) (1) from U.S. Provisional Patent Application Ser. No. 61/396,905 filed Jun. 04, 2010, of common inventorship herewith entitled, “Laundry Buddy.”

### FIELD OF THE INVENTION

The present invention pertains to the field of laundry cart devices, and more specifically to the field of wheeled laundry cart devices.

### BACKGROUND OF THE INVENTION

The prior art has put forth several designs for wheeled laundry cart devices. Among these are:

U.S. Pat. No. 7,252,295 to Aaron Bludworth describes a household and shopping laundry cart with a cart basket, tow handle, stair-climber incline device, an extendable basket cover and tapered sidewalls.

U.S. Pat. No. 7,494,136 to Manuel Alves and Pedro Dinis describes a rolling basket for storing and transporting goods which has casters enabling the basket to roll over the ground and a telescoping grasping arm deployed from the proximal wall.

US Patent Application Design D546,511 to Lavelle Luster illustrates an ornamental design for a laundry basket comprising wheels and a telescoping handle.

None of these prior art references describe the present invention.

### SUMMARY OF THE INVENTION

It is an object of the present invention to provide a wheeled laundry cart device.

### BRIEF DESCRIPTION OF THE DRAWINGS

FIG. 1 is an elevational angled perspective view of the device of the present invention with the handle extended.

FIG. 2 is an elevational angled perspective view of the device of the present invention with the handle in the secured position.

FIG. 3 shows a close-up elevational angled perspective view of a portion of the device of the present invention.

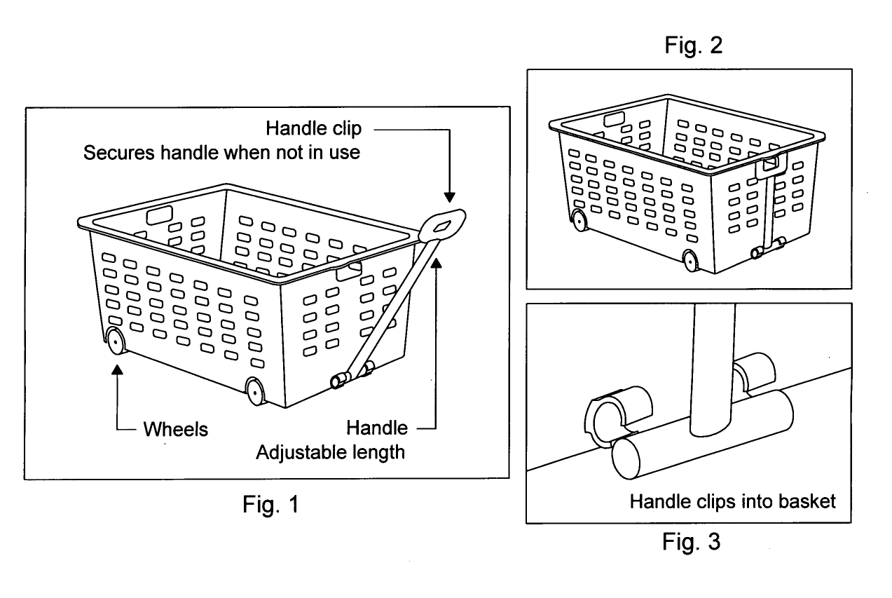

### DETAILED DESCRIPTION OF THE INVENTION

For many, doing laundry is a much disliked, but necessary chore. Lugging clothes to the laundry room or the local Laundromat, washing, drying, folding, and, in some cases, ironing can be an exhausting and daunting task. Most people wear an outfit only once or twice before it is thrown in a laundry basket to be laundered. Laundry baskets are useful items in that they provide a place to store soiled laundry until one is ready to do the wash. Unfortunately, when full, laundry baskets are for the most part, extremely heavy. Overflowing with dirty socks, undergarments and other clothing items, even the lightest of plastic laundry baskets can become cumbersome and awkward to move when filled. Furthermore, because of their size, most laundry baskets can be difficult to transport, particularly for those who suffer back pain, limited mobility or similar medical maladies.

The present invention, hereinafter referred as the Laundry Buddy, is a specially designed laundry basket, which boasts heavy duty wheels and an easily attached handle that enables the user to effortlessly transport the basket about the home. Similar in appearance to a traditional laundry basket, the Laundry Buddy is manufactured of heavy duty, yet lightweight plastic material. Sized appropriately to accommodate a full size load of laundry, the Laundry Buddy is rectangular shaped unit measuring approximately twenty-six and one half inches in length, approximately eighteen inches in width and approximately twelve inches in total depth. The Laundry Buddy boasts a mesh-like grate on the sidewalls, facilitating the free flow of air about laundry contained within. Positioned at either end of the unit are integrated handles for use in easily lifting the basket off the ground. Further, a recessed niche is centrally positioned on one end of the unit, inside of which, a sturdy handle is easily attached via an interlocking hinged fastener. As an added design feature, this handle is comprised of retractable, telescoping components and thus rests flush against the side of the basket when not in use, extending several feet in length when fully extended to accommodate the stature of an adult user. A nonskid, oval shaped handgrip is perpendicularly attached to the top of the handle, facilitating easy maneuvering of the Laundry Buddy. As mentioned, the most notable aspect of the Laundry Buddy is that this laundry basket features heavy-duty wheels which facilitate easy transport. As such, appropriately positioned on the underside of the four corners of the unit are four, durable wheeled castors which facilitate three hundred sixty degrees of rotation. The Laundry Buddy is produced in a myriad of attractive colors, as well as neutral white, beige and black hues.

Use of the Laundry Buddy is fairly simple and straightforward. The user first places this handy container in the desired area within the home, such as the laundry room, bathroom, bedroom or utility porch. The user then simply tosses soiled garments and linen within the unit, filling the Laundry Buddy to capacity. Once full, the Laundry

Buddy is simply rolled to the household washing machine, tossing the soiled clothing in the washer and dryer.

There are many benefits and advantages associated with this uniquely designed product invention. Foremost, the Laundry Buddy offers consumers a practical modification to the design of laundry baskets. A durable plastic laundry basket boasting heavy duty wheeled casters which enable the user to effortlessly roll the unit about the home, the Laundry Buddy ensures that one could move their laundry from the laundry closet, bedroom, kids room, or any where else in the house, and to the household laundry machine, in a simple manner. Featuring an ergonomically designed and adjustable handle, the Laundry Buddy is easily maneuvered while one stands comfortably upright. Eliminating the need to lug a heavy laundry basket by hand, the Laundry Buddy enables consumers to complete their laundry chores in a comfortable fashion. Although ideal for use by virtually any consumer, the Laundry Buddy proves particularly ideal for use by seniors, those who suffer back pain or limited mobility. Other significant advantages are related to the product's superior construction. Manufactured of sturdy plastic material, the Laundry Buddy withstands years of rugged and repeated use. Simple and attractive in design, the Laundry Buddy complements any home decor. In addition to home use, the Laundry Buddy also proves a valuable tool for professional cleaning agencies or hotel and resort housekeeping services.

Combining form with function, the Laundry Buddy is a unique product invention that offers consumers a convenient means of transporting soiled clothing for wash. Providing ample storage, this cleverly designed laundry basket facilitates the task of doing laundry in a quick and easy manner.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A wheeled laundry cart device, comprising a laundry basket, heavy duty wheels, a detachable handle, and manufactured of heavy duty, lightweight plastic material, sized appropriately to accommodate a full size load of laundry, an essentially rectangular shaped unit measuring approximately twenty-six and one half inches in length, approximately eighteen inches in width and approximately twelve inches in depth, further comprising a mesh-like grate on the sidewalls, facilitating the free flow of air, further comprising integrated gripping handles at opposite ends of the device, further comprising a recessed niche centrally positioned on one end of the unit, inside of which is positioned a sturdy retractable handle attached by means of an interlocking hinged fastener, and wherein the retractable handle comprises telescoping components and rests flush against the side of the basket when retracted and extends in length when fully extended to accommodate the stature of an adult user.

2. The device of claim 1 further comprising a nonskid, oval shaped handgrip perpendicularly attached to the top of the retractable handle.

3. The device of claim 1 wherein the heavy-duty wheels which facilitate easy transport are appropriately positioned on the underside of the four corners of the unit comprising four, durable wheeled castors which facilitate three hundred sixty degrees of rotation.

4. The device of claim 1 produced in a myriad of attractive colors, as well as neutral white, beige and black hues.
